(19) United States
(12) Patent Application Publication
(10) Pub. No.: US 2008/0050270 A1
(43) Pub. Date: Feb. 28, 2008

(54) Neutron Absorption Effectiveness for Boron Content Aluminum Materials

(76) Inventors: Xiao-Guang Chen, Quebec (CA); Ghyslain Dube, Quebec (CA); Nigel Steward, Quebec (CA)

Correspondence Address: BANNER & WITCOFF, LTD., TEN SOUTH WACKER DRIVE, SUITE 3000, CHICAGO, IL, 60606, US

(21) Appl. No.: 11/568,172

(22) PCT Filed: Apr. 21, 2005
(86) PCT No.: PCT/CA05/00610

§ 371 Date: Jun. 12, 2007

Related U.S. Application Data
(60) Provisional application No. 60/564,919, filed on Apr. 22, 2004.

(51) Int. Cl. G21F 1/08; C22B 21/00; C22C 21/00; C22C 32/00

(52) U.S. Cl. 420/552; 75/684

(57) ABSTRACT

A method is described for improving neutron absorption in aluminum-based cast composite material, which comprises preparing a molten composite from an aluminum alloy matrix and aluminum-boron intermetallics containing relatively large boron-containing particles, and either (a) heating the composite and holding for a time sufficient to partially dissolve the boron-containing particles and then adding titanium to form fine titanium diboride particles, and casting the composite, or (b) adding gadolinium or samarium to the molten composite or to the aluminum alloy matrix and casting the composite to precipitate fine particles of Gd—Al or Sm—Al within the cast composite, said fine particles filling gaps around the large boron-containing particles with neutron absorbing material. A neutron absorbing cast composite material is obtained comprising neutron absorbing compounds in the form of large particles comprising B₄C or an aluminum-boron intermetallic and a distribution of fine particles or precipitates comprising TiB₂ or (AlTi)B₂, Sm-aluminum intermetallic compounds or Gd-aluminum intermetallic compounds.

### CROSS REFERENCE TO RELATED APPLICATIONS

This application claims, the benefit of priority of the filing date of 21 Apr. 2005 of (1) a Patent Cooperation Treaty patent application, Serial Number PCT/CA2005/000610, filed on the aforementioned date, the entire contents of which are incorporated herein by reference, wherein Patent Cooperation Treaty patent application Serial Number PCT/CA2005/000610 was published under PCT Article 21(2) in English, and (2) the filling date of 22 Apr. 2004 of U.S. provisional patent application, Ser. No. 60/564,919, filed on the aforementioned date, the entire contents of which are incorporated herein by reference

### TECHNICAL FIELD

The present invention relates to methods of improving the neutron absorption effectiveness in boron-based neutron absorber materials.

### BACKGROUND ART

There is a great interest in the nuclear energy industry for construction materials which will absorb, and therefore not release, neutrons, e.g. in containers for waste fuel. The containers are predominantly made of aluminum (Al)-based materials. Boron (B) is a commonly used element for neutron absorbing. Boron can be typically incorporated into Al as B₄C, TiB₂ or simply B that forms AlB₂ or AlB₁₂ in an Al-matrix.

There are generally two types of container products available: Al—B₄C powder metallurgy products such as Boral™ (AAR Brocks & Perkins) in which aluminum alloy powder is mixed with boron carbide particles, and isotope-enriched Al—B products such as those by Eagle-Picher Technologies LLC. Because of their complicated processes, both products are very expensive.

Skibo et al. U.S. Pat. No. 4,786,467 describes a method of making aluminum alloy composites in which a variety of non-metallic particles are added to the aluminum alloy matrix. The particles include boron carbide, but are primarily silicon carbide particles.

Lloyd et al. EP 0 608 299 describes a procedure where alumina particles are dispersed in an aluminum alloy containing about 0.15 to 3% Mg where strontium is added to suppress the formation of spinels, which otherwise form and deplete the matrix of available magnesium.

Ferrando et al. U.S. Pat. No. 5,858,460 describes a method of producing a cast composite for aerospace applications using boron carbide in a magnesium-lithium or aluminum-lithium alloy wherein a silver metallic coating is formed on the particle surfaces before mixing them into the molten alloy to overcome a problem of poor wettability of the particles by the alloy and reactivity.

Pyzik et al. U.S. Pat. No. 5,521,016 describe a method of producing an aluminum-boron carbide composite by infiltrating a boron-carbide preform with a molten aluminum alloy. The boron carbide is initially passivated by a heat treatment process.

Rich et al. U.S. Pat. No. 3,356,618 describes a composite for nuclear control rods formed from boron carbide or zirconium diboride in various metals where the boron carbide is protected by a silicon carbide or titanium carbide coating, applied before forming the composite. The matrix metals are high temperature metals however, and do not include aluminum alloys.

For safety reasons, boron-containing aluminum materials require a homogenous distribution of boron-containing particles in their microstructure. A minimum interval between boron-containing particles is simultaneously also required to maximize neutron absorption. However, with decreased boron content, uniform distribution of boron-containing particles becomes difficult to achieve and intervals between boron-containing particles also become larger as boron-containing particles grow in size.

Large spaces between boron-containing particles and non-uniform distribution both lead to channelling effects that result in neutrons passing between boron-containing particles and not being absorbed.

A number of attempts have been made to improve neutron absorption in aluminum cast composite materials. The article “Neutron Absorbers: Qualification and Acceptance Tests,” published by the US Nuclear Regulatory Commission, discusses requirements for B₄C—Al containing absorbing materials, with a focus on the powder metallurgy field. There is some discussion of the effect of particle form and size distribution on the efficiency of neutron absorption. U.S. Pat. No. 4,806,307 (Hirose, et al.) discloses a cast aluminum alloy containing Gd for neutron absorbing applications. The Al—Gd intermetallic particles are said to be small. U.S. Pat. No. 5,700,962 (Robin) discloses a composite containing B4C in a metal that can include Al, Gd, etc., and alloys of these elements. However, the composite is formed by a costly powder metallurgical route. Finally EP Published Application 0258178 (Planchamp) discloses Al—Sm, Cu—Sm and Mg—Sm as alloys suitable for neutron absorption. Broad ranges of composition are said to be useful and various fabrication techniques can be used, including casting. The alloys can also be reinforced by fibres including alumina, silicon carbide, boron carbide, etc. No detailed description of the processes or product morphology is provided.

It is therefore desirable to establish a method of producing boron-aluminum cast composite materials having uniformly and closely spaced neutron-absorbing components to reduce channelling effects.

### DISCLOSURE OF INVENTION

The present invention thus provides a method for improving neutron absorption in aluminum-based composite material, which comprises preparing a molten composite material from an aluminum alloy matrix and at least one of aluminum-boron intermetallics or B₄C whereby the composite contains relatively large boron-containing particles, and either

heating the composite to a temperature and for a time sufficient to partially dissolve the boron-containing particles and thereafter adding titanium to the molten composite to thereby form an array of fine titanium diboride particles within the composite, or

adding gadolinium or samarium to the molten composite or to the molten aluminum matrix used to produce the molten composite material and casting the composite to thereby form fine particles of Gd—Al or Sm—Al intermetallics within the composite, said fine particles or precipitates serving to fill gaps around the large boron-containing particles with neutron absorbing material.

The present invention also provides a neutron absorbing cast composite material comprising neutron-absorbing compounds in the form of particles in an aluminum matrix, wherein the particles include a distribution of large particles comprising at least one of B₄C or an aluminum-boron intermetallic and a distribution of small particles or precipitates comprising TiB₂, Gd-aluminum intermetallic compounds or Sm-aluminum intermetallic compounds.

### BRIEF DESCRIPTION OF DRAWINGS

The present invention will be described in conjunction with the following figures, wherein:

FIG. 1 is a schematic diagram of various B₄C particle distributions in an aluminum cast composite material;

FIG. 2 is a schematic diagram illustrating one embodiment of the method of the present invention;

FIG. 3 is a schematic diagram illustrating another embodiment of the method of the present invention;

FIG. 4 is a micrograph illustrating an Al—AlB₂ composite material prior to treatment by the methods of the invention;

FIG. 5 is a micrograph illustrating the Al—AlB₂ material of FIG. 4 following addition of titanium in accordance with one embodiment of the invention;

FIG. 6 is a micrograph illustrating an Al—AlB₂—B₄C material following addition of titanium in accordance with yet another embodiment of the invention as in FIG. 5;

FIG. 7 is a micrograph illustrating an Al—B₄C—Gd composite material prepared in accordance with another embodiment of the invention;

FIG. 8 is a micrograph illustrating an Al—B₄C composite material prior to treatment by the methods of the invention; and

FIG. 9 is a micrograph illustrating the Al—B₄C material of FIG. 8 following addition of titanium in accordance with one embodiment of the invention.

### BEST MODES FOR CARRYING OUT THE INVENTION

The present invention focuses on improving neutron absorbing capabilities of a cast composite by forming, in situ, fine neutron absorbing species that become positioned in uniform intervals around the larger neutron absorbing particles of the original cast composite and thereby improve neutron capture efficiency. Neutron absorbing materials do not always have the efficiency for neutron capture that would be predicted solely on the percent by volume of absorbing element, due to “form factors”, such as surface area and distribution in the cast composite.

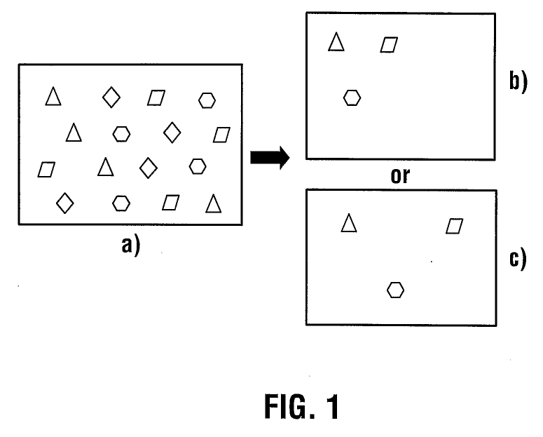

The existing problem with distribution of boron-containing particles is illustrated by FIG. 1, where FIG. 1a) shows a typical structure of boron-containing particles in a high boron-content composite material, with a boron content of approximately 16 wt %. FIG. 1b) shows the non-uniform distribution that occurs in low boron-content composites, for example in the range of 3 wt % boron. Finally, FIG. 1c) illustrates the large intervals that can lie between boron-containing particles, in such low boron-content composites.

In one embodiment, fine particles are precipitated in the metal cast composites by heating the composite to a higher temperature, for example 700 to 850° C., holding at temperature for a period of time, for example at least 15 minutes and then adding titanium to the molten composite to precipitate fine titanium diboride particles.

To improve the neutron absorption effectiveness in such materials, an approach has been proposed involving two steps: 1) partial dissolution of boron-containing particles at high temperatures; and 2) Ti addition after partial dissolution to form many small TiB₂ and (AlTi)B₂ particles. A combination of elevated temperature and holding time ensures that sufficient boron dissolves into solution in liquid aluminium such that the subsequent titanium addition rapidly forms a distribution of fine particles. A preferred temperature range for heating step is 730 to 820° C. and a preferred holding time is from 0.5 to 4 hours. If titanium is added earlier to the process it will react with the original boron containing particles to coat them and will not form significant numbers of fine particles in the matrix. A minimum holding time is needed to ensure adequate dissolution of the large boride particles and the presence of sufficient boron in solution to react with the added titanium.

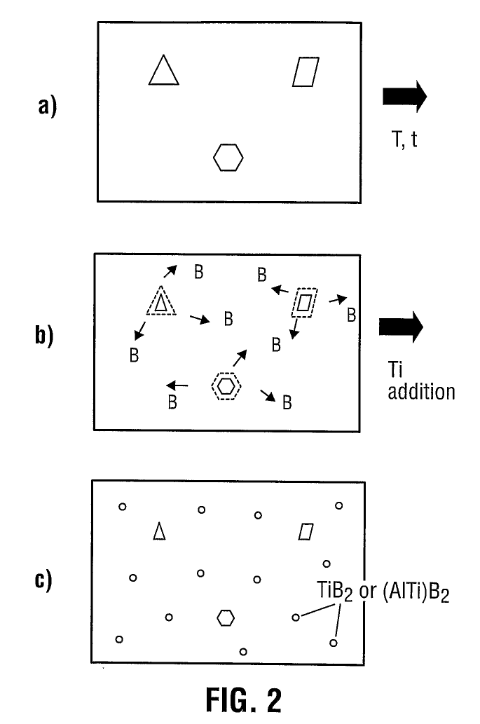

With reference to FIG. 2, at high melt temperature, the existing large boron-containing particles in the original composite, as shown in FIG. 2a), can be partially dissolved, and boron solubility in the liquid increases with increased melt temperature, as shown in FIG. 2b). Next, Ti is added, preferably in the range 0.2 to 2.0 wt % (measured as a percent by weight in the aluminum matrix), to form, in-situ, many small, boron-containing particles such as TiB₂ and (AlTi)B₂, as illustrated in FIG. 2c). These particles range in size from 0.1 to 5.0 μm and become distributed throughout the microstructure of the composite, thereby reducing intervals between boron-containing particles and providing better neutron shielding. By comparison the large boron-containing particles are at least 15 μm in average size, and may be as large as 50 μm in the case of B₄C particles and even larger in the case of Al—B intermetallics. If the titanium additions are too low, the number of particles will be insufficient, and if the titanium additions are too high, the titanium can form large aluminum-titanium intermetallics which are detrimental to mechanical properties in the final product.

The titanium can be added either as metallic powder or in the form of a commercially-available Al—Ti master alloy. The latter contains aluminum-titanium intermetallics which dissolve to add titanium into solution, but as long as the effective amount of titanium added lies within the preferred range, the detrimental effects of large intermetallics above are avoided.

For a given boron level, particularly in low boron-content aluminum based materials of typically 2-6% B, this method can increase the neutron absorption effectiveness. In addition, many small in-situ formed TiB₂ particles may-increase the material strength at both room temperature and elevated temperatures.

This method can be used for Al—B alloys, Al—B₄C composites as well as their combination. The process can be applied to either new materials or to materials that have been re-melted and recycled.

In nature, there are several elements that have a higher neutron absorbing capacity than Boron. Among them, Gadolinium (Gd) and Samarium (Sm), as shown in Table 1, have been found to be very promising as neutron absorbers because of their higher neutron absorbing capacity. For example, at an energy level of 0.025 eV for thermal neutrons, Gd has a 64 times higher capacity and Sm has a 7.7 times higher capacity than boron to absorb neutrons. In addition, gadolinium and samarium are also readily available in the form of metal lumps, chunks, ingots, rods and plates, which are easy for alloying with aluminum. They have also recently become more reasonably priced.

TABLE 1
Neutron Absorbing Capacity of Different Elements

| | | | | Thermal neutron |
|---|---|---|---|---|
| | | % | Thermal neutron | absorption cross |
| | | isotope | absorption cross | section of the |
| | Isotope | in the | section of the isotope | element for |
| Element | useful | element | for 2200 m/s neutrons | 2200 m/s neutrons |
| B | ¹⁰B | 20 | 3835 | 767 |
| Sm | ¹⁴⁹Sm | 13.9 | 42080 | 5922 |
| Gd | ¹⁵⁷Gd | 15.7 | 259000 | 49700 |
| | ¹⁵⁵Gd | 14.8 | 61100 | |

Thus in accordance with another embodiment of the invention, fine particles are precipitated by adding gadolinium (Gd) or samarium (Sm) to the molten composite or by adding Gd or Sm to the aluminum alloy used to produce the initial composite. By alloying a relatively small quantity of Gd or Sm into the Al—B₄C metal matrix composite, Al—B₄C—Gd and Al—B₄C—Sm MMCs work as highly efficient materials with a relatively low cost for neutron absorber applications. For example, by adding 0.31 wt % Gd or 2.6 wt % Sm to an Al-25 vol % B₄C composite material, the neutron absorbing capacity of the material is nearly doubled. The effectiveness of these alloying elements is dependent on the energy of the neutrons being adsorbed.

Preferably, to achieve a useful effect on neutron absorption, the Gd concentration in Al—B₄C is at least 0.2 wt % and the Sm concentration in Al—B₄C is at least 0.5 wt %. The upper limit on concentration of the Gd or Sm is approximately the eutectic point in the composition. For example the preferred upper limit on concentration for Gd is about 23% and Sm is about 15 wt %. Concentrations of Gd and Sm (which are given above as weight percent in the aluminum matrix) up to these levels are useful to ensure enhanced neutron absorption over a range of neutron energies, since the effectiveness of absorption is dependent on this parameter. Raising the Gd and Sm contents is also advantageous in that the fluidity of the mixture increases, making casting of the material easier. However, concentrations that significantly exceed the eutectic point are less useful, as large Gd or Sm primaries may form that are detrimental to castability and are less effective in enhancing the neutron absorption. The precipitated Gd or Sm containing intermetallic compounds typically will have a size range of 0.1 to 10 μm.

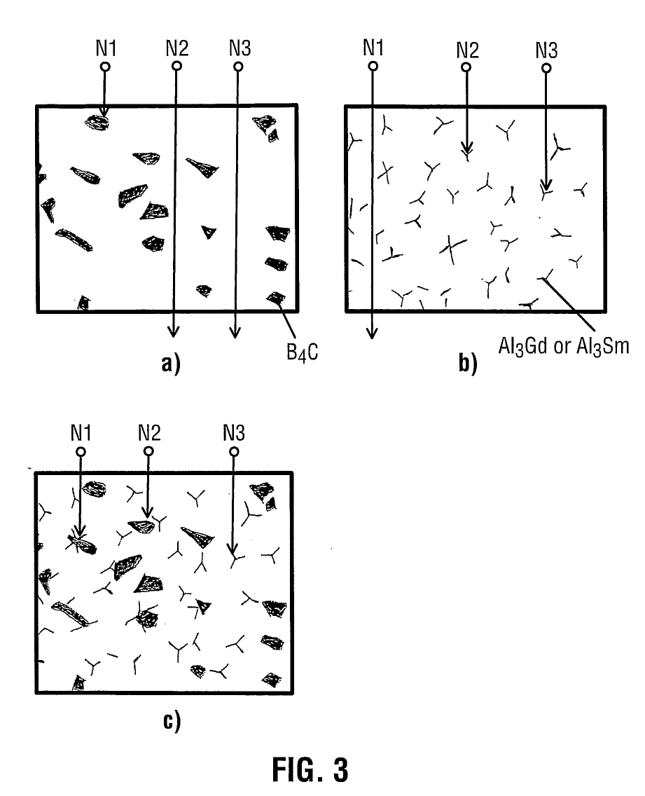

As indicated earlier, the effectiveness of the neutron absorber material can be influenced by particle distribution and morphology. The random distribution of B₄C that naturally occurs in the aluminum matrix can result in channelling due to non-uniform distribution. This is seen in FIG. 3a). Gd and Sm components, in the form of, for example, Al₃Gd and Al₃Sm intermetallics, tend to occupy the aluminum cell boundaries and have a more uniform distribution at a fine scale. This is depicted in FIG. 3b), which shows that channelling of neutrons N1, N2 and N3 is lessened by the additions of the intermetallic particles. Combining these intermetallics in the cast composite material greatly reduces the channelling effect for neutron escape and, therefore, provides better neutron shielding. This is depicted in FIG. 3c).

In a preferred embodiment, additional alloying can be done to the Al—B₄C—Gd and Al—B₄C—Sm MMCs, using Si, Mg, Mn, etc. in combination with proper heat treatment, to produce different mechanical and/or material properties to meet various nuclear waste storage requirements.

Adding Gd or Sm to replace a considerable amount of B4C, may also simplify casting and downstream manufacture processes. Due to the relatively small quantity of Gd or Sm addition to achieve a particular neutron absorption, the composite material can maintain mechanical properties, weldability and corrosion resistance.

Al—B₄C—Gd and Al—B₄C—Sm MMCs can also be manufactured into products such as shaped castings for end use, cast billets or ingots for further processing into extruded shapes or rolled plates and sheets.

The present invention also provides a neutron absorbing cast composite containing neutron absorbing compounds in the form of particles in an aluminum matrix, wherein the size distribution of the particles is bimodal, with a distribution of large particles comprising B₄C or an Al-boride intermetallic, and a distribution of small particles or precipitates comprising TiB₂ or (AlTi)B₂, Sm-aluminum intermetallic compounds or Gd-aluminum intermetallic compounds.

### EXAMPLE 1

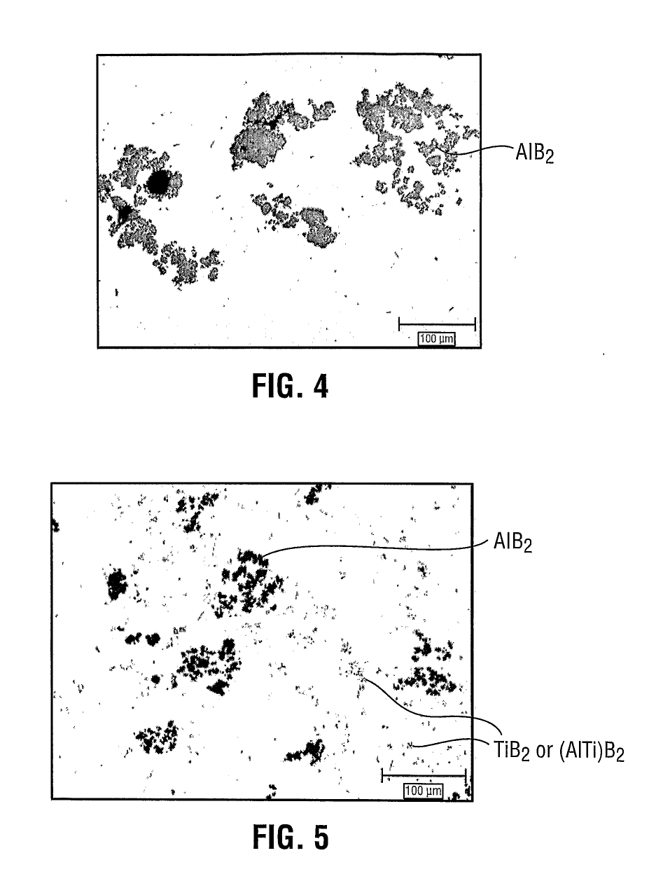

An Al-2.5 wt % B alloy was prepared using a commercial Al-4% B master alloy. A micrograph of a solid sample of the prepared material is shown in FIG. 4, illustrating that large AlB2 intermetallic particles characteristic of such a material. After melting, the material was held for 2 hours at 800° C. to partially dissolve the original large boron-containing particles (AlB₂). Thereafter, 0.7 wt % Ti was added into the molten metal to form in-situ many fine boron-containing species (TiB2 or (AlTi)B₂) and the composite was subsequently cast in the form of an ingot. FIG. 5 is a micrograph of a sample taken from the ingot, and indicates that these fine species are uniformly positioned between larger AlB₂ particles of the original cast alloy.

### EXAMPLE 2

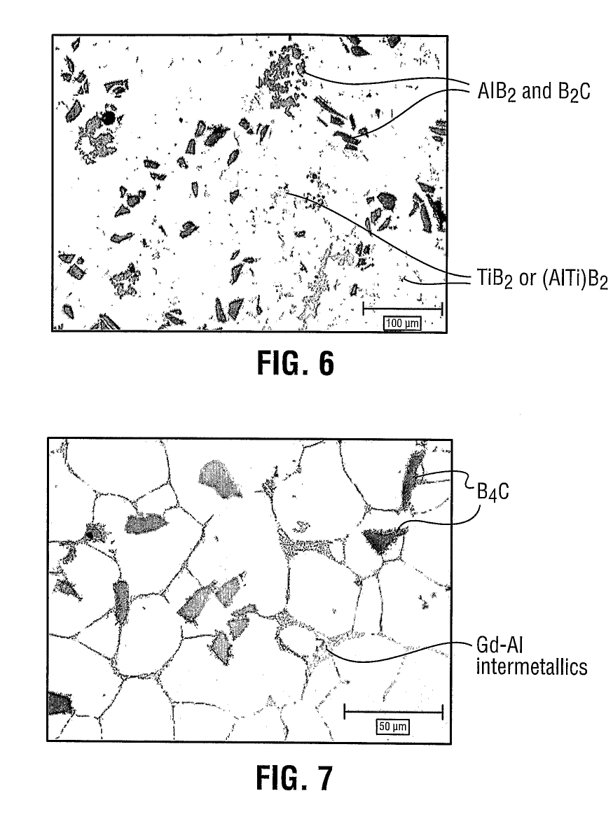

An Al-1.0 wt % B alloy was first prepared using a commercial Al-4% B master alloy. After melting, 3.0 wt % B₄C powder was added into the molten metal to form an Al—B₄C—B composite material. The molten composite was held for 2 hours at 800° C. to partially dissolve the original large boron-containing particles (AlB₂ and B₄C). Thereafter, 0.3 wt % Ti was added into molten composite and then the composite was cast in the form of a cylindrical ingot. FIG. 6 illustrates a sample taken from an ingot cast from this treated composite and reveals many in-situ formed fine boron-containing species (TiB₂ or (AlTi)B₂) that are well distributed to fill the gaps between larger AlB₂ and B₄C particles.

### EXAMPLE 3

An Al—B₄C—Gd composite was prepared. First, 2 wt % Gd was added to molten aluminum to batch an Al-2% Gd alloy. Then 8 wt % B₄C powder was added to this molten alloy to form an Al-8% B₄C-2% Gd composite, and thereafter the composite was cast in the form of a cylindrical ingot. A sample of the cast ingot was taken and FIG. 7 shows a micrograph of the sample, illustrating that during solidification of the ingot, fine Gd—Al intermetallics form and tend to occupy aluminum grain boundaries. Combining these intermetallics in the cast Al—B₄C composite material greatly reduces the intervals between larger neutron absorbing compounds (B₄C).

### EXAMPLE 4

Various Al—B₄C—Sm composites were prepared. First, 1 to 5 wt % Sm was add to molten aluminum, then 5 to 10 wt % B₄C powder was added to molten alloys to from Al—B₄C—Sm composite materials. During solidification, fine Sm—Al intermetallics form on aluminum grain boundaries. The samples taken from the cast ingots indicated that the microstructures of Al—B₄C—Sm are very similar to the Al—B₄C—Gd as shown in FIG. 7, in which a bimodal distribution of larger B₄C particles and finer Sm—Al intermetallic precipitates was found.

### EXAMPLE 5

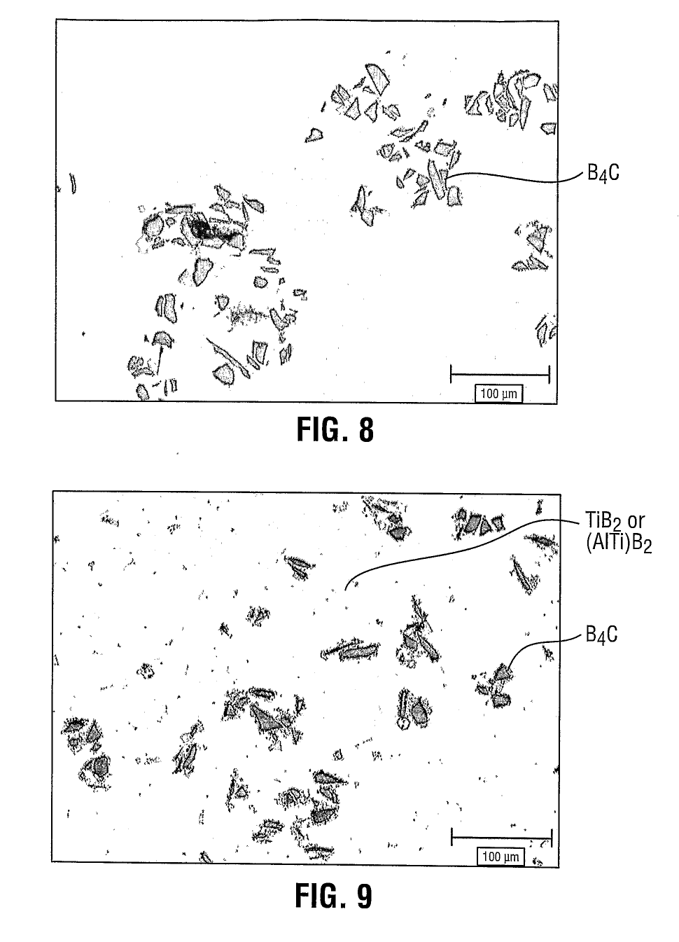

An Al-4 wt % B₄C molten composite was prepared by stirring the carbide powder into molten aluminum. A solidified sample of this material is shown in FIG. 8 with a distribution of large B₄C particles visible. The molten composite was held for 2 hours at 800° C. to partially dissolve the original large boron-containing particles (B₄C). Thereafter 1.0 wt % Ti was added into the molten metal to form in-situ many fine boron-containing species (TiB₂ or (AlTi)B₂) and subsequently cast. FIG. 9 shows a micrograph of a sample taken from the cast ingots and indicates that these fine species are uniformly positioned between larger B₄C particles to fill the gaps in between.

This detailed description of the methods and products is used to illustrate the prime embodiment of the present invention. It will be obvious to those skilled in the art that various modifications can be made in the present method and that various alternative embodiments can be utilized. Therefore, it will be recognized that various modifications can be made in both the method and products of the present invention and in the applications to which the method and products are applied without departing from the scope of the invention, which is limited only by the appended claims.

1. A method for improving neutron absorption in aluminum-based cast composite material, which comprises:
(a) preparing a molten composite material from an aluminum alloy matrix and at least one of aluminum-boron intermetallics or B₄C whereby the composite contains relatively large boron-containing particles; and
(b) either heating the composite to a temperature and for a time sufficient to partially dissolve the boron-containing particles and thereafter adding titanium to the molten composite to form an array of fine titanium diboride particles within the composite, and casting the composite; or adding gadolinium or samarium to the molten composite or to the aluminum matrix used to produce the molten composite material and casting the composite to thereby precipitate fine particles of Gd—Al or Sm—Al within the cast composite, said fine particles or precipitates serving to fill gaps around the large boron-containing particles with neutron absorbing material.

2. The method of claim 1 wherein the composite material is heated to a holding temperature in the range of from 700 to 850° C.

3. The method of claim 2 wherein the composite material is held at the holding temperature for 15 minutes or more.

4. The method of claim 3 wherein the composite material is held at the holding temperature for 0.5 to 4 hours.

5. The method of claim 1 wherein titanium is added in an amount of 0.2 to 2.0 wt %.

6. The method of claim 1 wherein the fine titanium diboride particles are TiB₂ or (AlTi)B₂ particles.

7. The method of claim 1 wherein the fine titanium diboride particles range in size from 0.1 to 5.0 μm.

8. The method of claim 1 wherein Gd is added to the molten composite in an amount ranging from 0.2 to 23.0 wt %.

9. The method of claim 1 wherein Sm is added to the molten composite in an amount ranging from 0.5 to 15.0 wt %.

10. A neutron absorbing cast composite material comprising neutron-absorbing compounds as particles in an aluminum matrix, wherein the particles include a distribution of large particles comprising B₄C or an aluminum-boron intermetallic and a distribution of small particles or precipitates comprising TiB₂, (AlTi)B₂, Sm-aluminum intermetallic compounds or Gd-aluminum intermetallic compounds serving to fill gaps around the large boron-containing particles within the neutron absorbing material.

11. The cast composite material of claim 10 comprising from 0.2 to 2.0 wt % titanium.

12. The cast composite material of claim 10 wherein the small particles of TiB₂ or (AlTi)B₂ have a size range from 0.1 to 5.0 μm.

13. The cast composite material of claim 10 comprising from 0.2 to 23.0 wt % Gd.

14. The cast composite material of claim 10 the composite was cast in the form of a cylindrical ingot comprising from 0.5 to 15.0 wt % Sm.

15. The cast composite material of claim 10 wherein the Gd or Sm containing intermetallics have a size range of 0.1 to 10.0 μm.

16. The cast composite material of claim 10 wherein the large particles of B₄C or aluminum-boron intermetallic are at least 15 μm in average size.
